(19) United States
(12) Patent Application Publication
(10) Pub. No.: US 2007/0267861 A1
(43) Pub. Date: Nov. 22, 2007

(54) Integrated album page and product sheet

(76) Inventor: Alan Chun Ming Chiu, Kowloon (HK)

Correspondence Address: WILLIAM W. HAEFLIGER, 201 S. LAKE AVE, SUITE 512, PASADENA, CA, 91101, US

(21) Appl. No.: 11/418,518

(22) Filed: May 5, 2006

(51) Int. Cl. B42D 1/00

(52) U.S. Cl. 281/38

(57) ABSTRACT

An assembly including an album page adapted for inclusion on an album for displaying an applied display sheet, comprising in a page having retention shoulders proximate page corners, and a transparent protector sheet loosely applied to the page to extend over the display sheet and having edges retained by shoulders to orient the protector sheet relative to the page and the display sheet.

### BACKGROUND OF THE INVENTION

This invention relates generally to albums, as for example used to display pictures of photographs; and more particularly concerns provision of quick efficient protection of photographs or pictures applied to album pages.

There is need for a way to easily, rapidly and positively protect display sheets, such as photographs and other display means, as mounted on album pages. There is also need for a way to remove applied protector means, to facilitate access to the mounted display sheets, as for example to enable mounting of another display sheet to the album page, or to adjust the originally mounted display sheet, and subsequent rapid re-deployment of the protective sheet or sheets. There is also need for a way to retain the protective sheet in a pre-determined oriented condition on the album page, without positively attaching it to the album page.

### SUMMARY OF THE INVENTION

It is a major object of the invention to provide apparatus and method to meet the above multiple needs. Basically, the apparatus comprises, for an album page the following:

a) the page having retention shoulders proximate page corners,

b) and a looping transparent protector sheet loosely applied to said page to extend over the display sheet and having edges retained by said shoulders to orient the protector sheet relative to the page and the display sheet.

As will appear, first and second shoulders are typically defined at opposite ends of an elongated cut-out at an upper edge of the album page. Also, third and fourth of the shoulders are typically defined at opposite ends of a secondary elongated cut-out at the lower edge of the page.

In assembled condition, the transparent protector sheet may have a primary elongated edge portion configured in said primary cut-out, between said first and second shoulders, and a secondary elongated edge portion confined in said secondary cut-out, between the third and fourth shoulders. As will appear, one of the primary and secondary edge portions is defined by a protector sheet fold; and the other of said primary and secondary edge portions is defined by protector sheet bonded edge extents.

A further object is to provide the first and second shoulders formed by first and second page corner ears positioned to orient the protector sheet in predetermined location (for example centered) relative to the album page and display sheets such as photographs attached to it.

Yet another object is to provide a method of forming the assembly as referred to, and including the steps:
x₁) folding the transparent sheet and bonding registered edges thereof to form a looping sheet configuration,
x₂) mounting a display sheet to the album page,
x₃) and looping the folded transparent sheet over the page in over-riding relation to at least two ears, to extend from said primary cut-out to said secondary cut-out for retention between said first and second shoulders, and between said third and fourth shoulders, to the display sheet.

That method may also advantageously include bowing the page to displace its cut-outs relatively toward one another, to enable said looping step.

An additional object is to provide the ears to be over-ridden by the looping transparent sheet, while the display sheet is in bowed condition. Relieving of bowing enables the transparent sheet to be edge oriented by the cut-outs, in overlapping relation to the photograph or photographs on the display sheet or page. Subsequent bowing of the display sheet in the album enables removal of the transparent sheet over two ears of the display sheet, enabling access to the photographs, for re-orientation, or for additional mounting of new photos.

These and other objects and advantages of the invention, as well as the details of an illustrative embodiment will be more fully understood from the following specification and drawings, in which:

### DRAWING DESCRIPTION

FIG. 1 shows, an edge view, initial folding of a transparent sheet;

FIG. 2 shows bonding of folded together edges of the transparent sheet;

FIG. 3 shows the assembly of the folded transparent sheet onto an album page, with use of cut-outs and retention ears; and

FIG. 4 shows bowing of the display sheet to enable assembly of the transparent sheet over two ears, and onto the display sheet.

### DETAILED DESCRIPTION

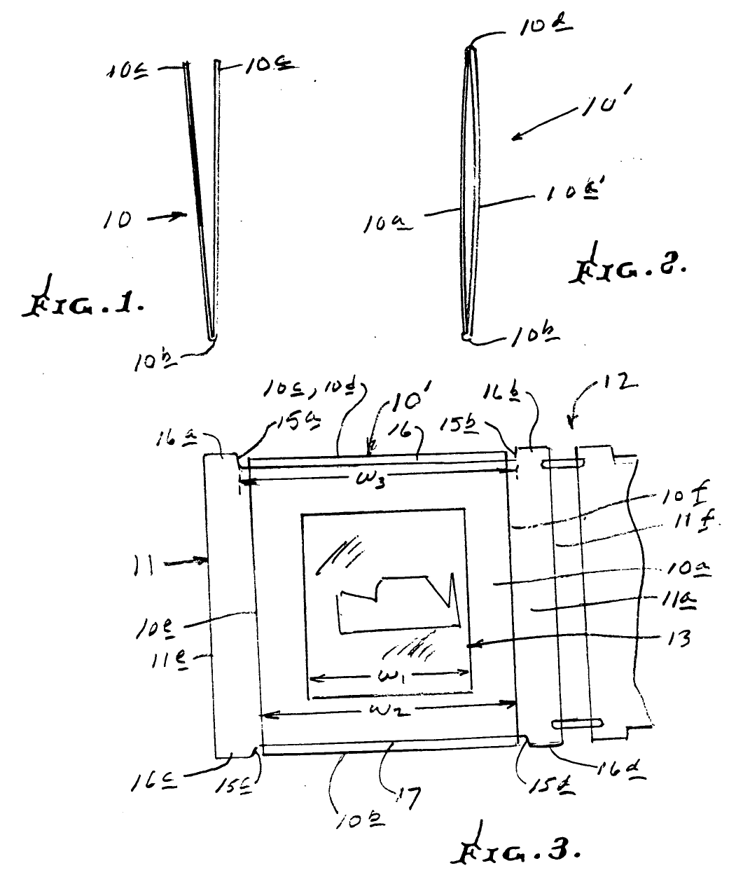

In FIG. 1, a transparent protective sheet 10 is initially folded to form two like sections 10a, connected by a folded edge 10b. In FIG. 2, the free edges 10c of the sections are connected, as by bonding, to produce a very narrow-width sealed edge 10d. A looping protector sheet 10′ is thereby produced. The sections can alternatively be integral at edge 10d, in the shape of a fold.

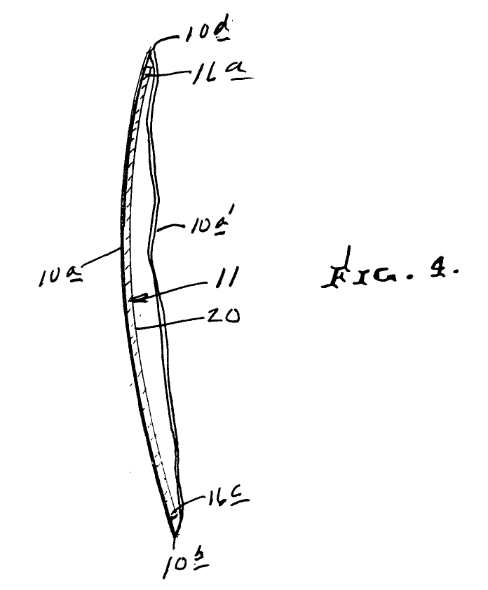

The resultant protector sheet 10′ is then loosely applied to i.e. over the page 11 of album 12. Page 11 has a display sheet or sheets, such as a photograph 13, or photographs, mounted to at least one side 11a of the page. The protector sheet 10′ is slipped edgewise over the page 11, so that one face section 10a extends proximate the side 11a and over the display sheet 13, and the other section 10a′ extends proximate the opposite side 11b of the page. See FIGS. 3 and 4.

As shown, the page 11 of the album has retention shoulders proximate page corners. See for example first and second retention shoulders 15a and 15b defined at opposite ends of a primary elongated laterally extending cut-out 16 at the upper edge of the page; and third and fourth of such shoulders 15c and 15d defined at opposite ends of a secondary elongated laterally extending cut-out 17 at the lower edge of the page, longitudinally spaced from the primary cut-out.

Shoulders 15a and 15b are respectively formed by upwardly projecting corner ears 16a and 16b of the album page; and shoulders 15c and 15d are respectively formed by downwardly projecting corner ears 16c and 16d of the album page. Such ears are narrow in width (height above the cut-out bottom), i.e. typically less than 3/16 inch in width.

The transparent, protective, looping sheet 10′ is typically assembled progressively edgewise and laterally over the page ears 16a and 16c and toward ears 16b and 16d, until folded edges or ends 10b and 10d register with the elongated cut-outs, and so that shoulders 15a and 15b retain one of the edges 10c and 10d in cut-out 16; and so that shoulders 15c and 15d retain the other of the edges 10b in cut-out 17. The lengths of the edges 10b, 10c and 10d are typically about the same, and slightly less than the lengths of the cut-outs 16 and 17.

This construction assures that the protector sheet 10′ will be oriented to protectively extend over the display sheet or sheets 13 mounted on the album page and so that sheet lengthwise edges 10e and 10f extend generally parallel to page edges 11e and 11f. See FIGS. 3 and 4. Display sheet 13 is shown as having lateral width w₁ less than the width w₂ of the protective sheet 10′, and less than the like lateral widths w₃ of the cut-outs, i.e.
w₁<w₂ and w₁<w₃

FIG. 4 shows how the sheet 10′ can be assembled over projecting ears 15a and 16a. This is accomplished by in situ bowing of the album page at region 20 between ears 16a and 16c, and to lesser extent than any bowing of the page at region 21 between ears 16b and 16d, i.e. with the page 11 remaining mounted in the album. Region 21 is closer to the page edge binding region 22 of the album than region 20. Such bowing at region 20 moves ears 16a and 16c closer to one another to enable slip-over of the looping sheet 10′, or removal of that sheet from installed position, to facilitate adjustment of the display sheet 13 or sheets, for addition or removal of display sheets. Accordingly, an easily shiftable protective sheet is provided, for inter-fit with an album page in fixed protective position.

The overall method includes the steps:
x₁) folding said transparent sheet and bonding edges thereof to form a looping sheet configuration,
x₂) mounting a display sheet to said page,
x₃) and looping said folded transparent sheet over the page in over-riding relation to at least two ears, to extend from said primary cut-out to said secondary cut-out for retention between said first and second shoulders, and between said third and fourth shoulders, to protect the display sheet.
   The method may also include preliminarily forming said first, second, third and fourth page shoulders and said cut-outs, bowing said page to displace said cut-outs relatively toward one another, and slipping said transparent sheet edgewise off said page, over-riding two formed ears, to enable access to the display sheet mounted to the page.

I claim:

1. An assembly including an album page adapted for inclusion on an album for displaying an applied display sheet, comprising in combination:
a) said page having retention shoulders proximate page corners,
b) and a looping transparent protector sheet loosely applied to said page to extend over the display sheet and having edges retained by said shoulders to orient the protector sheet relative to the page and the display sheet.

2. The combination of claim 1 wherein first and second of said shoulders are defined at opposite ends of an elongated cut-out at an upper edge of the page.

3. The combination of claim 1 wherein:
i) first and second of said shoulders are defined at opposite ends of a primary elongated cut-out at the upper edge of the page, and
ii) third and fourth of said shoulders are defined at opposite ends of a secondary elongated cut-out at the lower edge of the page.

4. The combination of claim 3 wherein the transparent protector sheet includes a primary elongated edge portion confined in said primary cut-out, between said first and second shoulders, and a secondary elongated edge portion confined in said secondary cut-out, between said third and fourth shoulders.

5. The combination of claim 4 wherein one of said primary and secondary edge portions is defined by a protector sheet fold.

6. The combination of claim 5 wherein the other of said primary and secondary edge portions is defined by protector sheet bonded together edge extents.

7. The combination of claim 2 wherein said first and second shoulders are formed by page first and second corner ears.

8. The combination of claim 3 wherein said first and second shoulders are formed by page first and second corner ears, and said third and fourth shoulders are formed by page third and fourth corner ears.

9. The method of forming the assembly of claim 3, that includes:
x₁) folding said transparent sheet and bonding registered edges thereof to form a looping sheet configuration,
x₂) mounting a display sheet to the album page,
x₃) and looping said folded transparent sheet over the page in over-riding relation to at least two ears, to extend from said primary cut-out to said secondary cut-out for retention between said first and second shoulders, and between said third and fourth shoulders, to protect the display sheet.

10. The method of claim 9 including bowing at least part of said page to relatively displace portions of said cut-outs toward one another, to enable said looping step.

11. The method of claim 9 including preliminarily forming said first, second, third and fourth page shoulders.

12. The method of claim 9 that includes bowing at least part of said page to displace portions of said cut-outs relatively toward one another, and slipping said transparent sheet edgewise off said page, over-riding page ears, to enable access to the display sheet mounted to the page.

13. The method of claim 12 including again bowing the display sheet and again looping the transparent sheet over the page to extend between said cut-outs, and relieving said bowing to enable transparent sheet edge retention between page ears.
